(19) United States
(12) Patent Application Publication
(10) Pub. No.: US 2009/0037655 A1
(43) Pub. Date: Feb. 5, 2009

(54) System and Method for Data Storage and Backup

(75) Inventors: Jacob Cherian, Austin, TX (US); Sanjeet Singh, Austin, TX (US); Rohit Chawla, Austin, TX (US); Eric Endebrock, Round Rock, TX (US); Brett Roscoe, Austin, TX (US); Matthew Smith, Austin, TX (US)

Correspondence Address: BAKER BOTTS L.L.P.;One Shell Plaza, 910 Louisiana, Houston, TX, 77002-4995, US

(73) Assignee: DELL PRODUCTS L.P., Round Rock, TX (US)

(21) Appl. No.: 11/830,272

(22) Filed: Jul. 30, 2007

(51) Int. Cl. G06F 12/00

(52) U.S. Cl. 711/114; 711/E12.002

(57) ABSTRACT

Systems and methods for data storage and backup are disclosed. A system for data storage and backup may include a storage array comprising one or more storage resources and an agent running on a host device, the agent communicatively coupled to the storage array. The agent may be operable to automatically allocate one or more storage resources for the storage of data associated with a backup job of the hose device and communicate the data associated with the backup job to the allocated storage resources.

### TECHNICAL FIELD

The present disclosure relates in general to data storage and backup, and more particularly to a system and method for data storage and backup.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput, and/or capacity. In operation, one or more storage resources disposed in an array of storage resources may appear to an operating system as a single logical storage unit or “virtual resource.” Implementations of storage resource arrays can range from a few storage resources disposed in a server chassis, to hundreds of storage resources disposed in one or more separate storage enclosures.

Often, storage resource arrays are used in connection with data backup. In general, “backup” refers to making copies of data so that the additional copies may be used to restore an original set of data after a data loss event. For example, data backup may be useful to restore an information handling system to an operational state following a catastrophic loss of data (sometimes referred to as “disaster recovery”). In addition, data backup may be used to restore individual files after they have been corrupted or accidentally deleted. In many cases, data backup requires significant use of storage resources. Organizing and maintaining a data backup system and its associated storage resources often requires significant management and configuration overhead.

In conventional data backup approaches, users often need to manage two management applications: (i) a backup application for managing backup operations, e.g., reading and writing data to backup storage resources, and (ii) a storage management application to provision, monitor, and manage the backup storage resources. Management of each of a backup application and a storage management application may cause management complexity. For example, in many instances, before a user may execute a backup application to backup data, the user must use the storage management application to ensure allocation of sufficient storage resources for the data to be backed up by the backup application.

### SUMMARY

In accordance with the teachings of the present disclosure, disadvantages and problems associated with data storage and backup may be reduced or eliminated. In particular embodiments, an agent may automatically allocate storage resources for a backup job, and communicate the data to be backed up to the allocated storage resources.

In accordance with one embodiment of the present disclosure, a system for data storage and backup may include a storage array comprising one or more storage resources and an agent running on a host device, the agent communicatively coupled to the storage array. The agent may be operable to automatically allocate one or more storage resources for the storage of data associated with a backup job of the host device and communicate the data associated with the backup job to the allocated storage resources.

In accordance with another embodiment of the present disclosure, an information handling system may include a processor, a memory communicatively coupled to the processor, and an agent. The agent may be communicatively coupled to the processor, the memory, and one or more storage resources. In addition, the agent may be operable to automatically allocate one or more storage resources for the storage of data associated with a backup job of the host device and communicate the data associated with the backup job to the allocated storage resources.

In accordance with a further embodiment of the present disclosure, a method for data storage and backup is provided. The method may include an agent running on a host device automatically allocating one or more storage resources for the storage of data associated with a backup job of the host device. The method may further include the agent communicating the data associated with the backup job to the allocated storage resources.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of a conventional system for storing backup data;

FIG. 2 illustrates a block diagram of an example system for storing backup data, in accordance with the teachings of the present disclosure;

FIG. 3 illustrates a flow chart of a method of initialization of the system depicted in FIG. 2, in accordance with the teachings of the present disclosure; and

FIG. 4 illustrates a flow chart of a method for storing backup data, in accordance with the teachings of the present disclosure.

### DETAILED DESCRIPTION

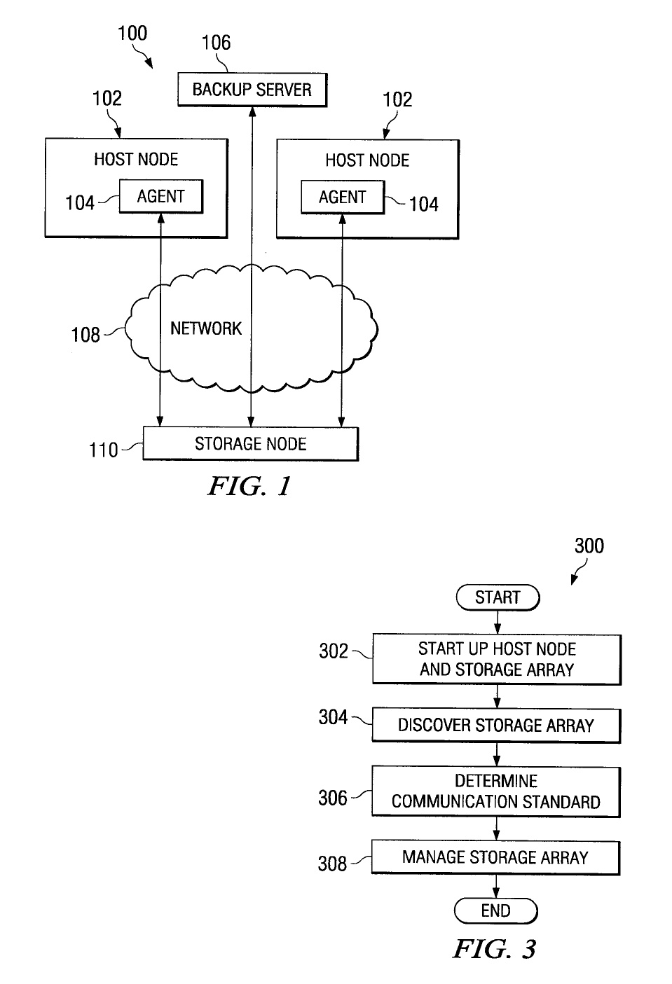

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

As discussed above, an information handling system may include an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “virtual resource.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, etc.

FIG. 1 illustrates a block diagram of a conventional system 100 for storing backup data. As depicted in FIG. 1, system 100 includes one or more host nodes 102, a backup server 106, a network 108, and a storage node 110. In addition, each host node 102 may include an agent 104 installed thereon. In operation, backup server 106 may communicate over network 108 to provision, monitor, and manage backup storage resources. For example, backup server 106 may generally be operable to create virtual resources and/or allocate virtual resources for use by host nodes 102. Each agent 104 running on host nodes 102 may facilitate the actual backing up of storage data by determining which data from its associated host node 102 requires backup, and communicating such data via network 108 to storage node 110, where the data may be stored to the virtual resources allocated by backup server 106.

As mentioned above, management of each of agent 104 and a backup server 106 may cause management complexity and/or inefficiency in system 100. For example, in many instances, before agent 104 may write backup data to storage node 110, the user must use backup server 106 to ensure allocation of sufficient storage resources for the data to be written by agent 104.

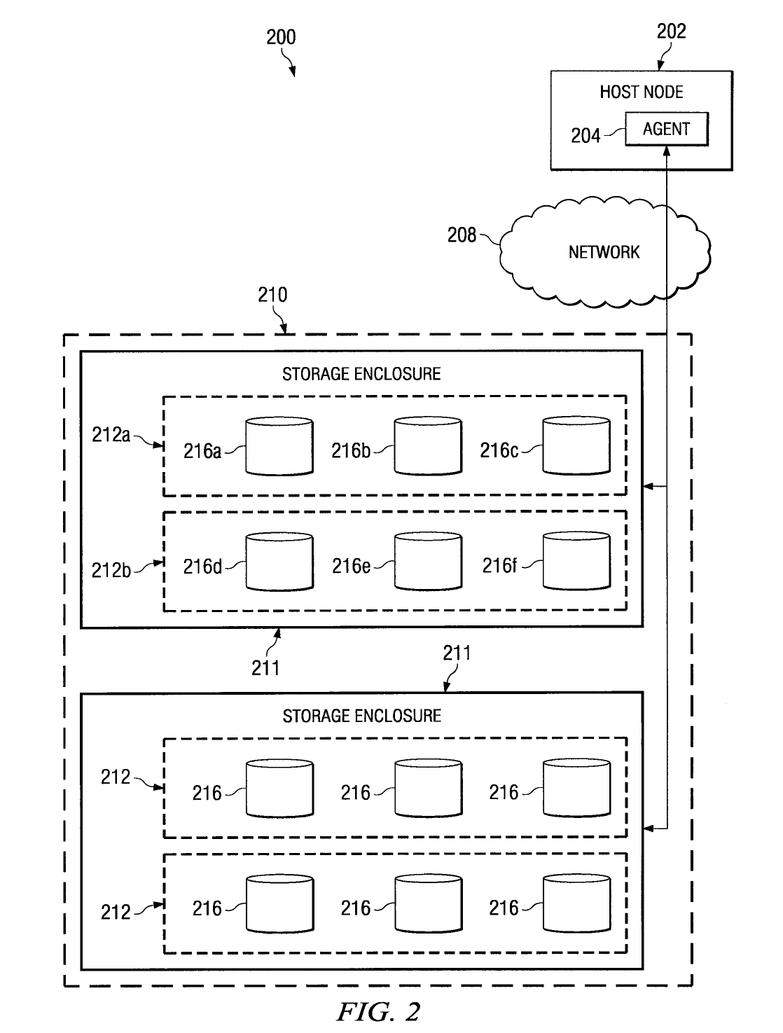

FIG. 2 illustrates a block diagram of an example system 200 for storing backup data, in accordance with the teachings of the present disclosure. As depicted, system 200 may include one or more host nodes 202, a network 208, and a storage array 210 comprising one or more storage enclosures 211. Host 202 may comprise an information handling system and may generally be operable to read data from and/or write data to one or more storage resources 216 disposed in storage enclosures 211. In certain embodiments, host 202 may be a server. Although system 200 is depicted as having one host 202, it is understood that system 200 may include any number of hosts 202.

Network 208 may be a network and/or fabric configured to couple host 202 to storage resources 216 disposed in storage enclosures 211. In certain embodiments, network 208 may allow host 202 to connect to storage resources 216 disposed in storage enclosures 211 such that the storage resources 216 appear to host 202 as locally attached storage resources. In the same or alternative embodiments, network 208 may include a communication infrastructure, which provides physical connections, and a management layer, which organizes the physical connections, storage resources 216 of storage enclosures 211, and host 202. In the same or alternative embodiments, network 208 may allow block I/O services and/or file access services to storage resources 216 disposed in storage enclosures 211. Network 208 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data, and/or messages (generally referred to as data). Network 208 may transmit data using any storage and/or communication protocol, including without limitation, Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), integrated drive electronics (IDE), and/or any combination thereof. Network 208 and its various components may be implemented using hardware, software, or any combination thereof.

As depicted in FIG. 2, storage enclosure 211 may be configured to hold and power one or more storage resources 216, and may be communicatively coupled to host 202 and/or network 208, in order to facilitate communication of data between host 202 and storage resources 216. Storage resources 216 may include hard disk drives, magnetic tape libraries, optical disk drives, magneto-optical disk drives, compact disk drives, compact disk arrays, disk array controllers, and/or any other system, apparatus or device operable to store data. Although the embodiment shown in FIG. 2 depicts system 200 having two storage enclosures 211, storage array 210 may have any number of storage enclosures 211. In addition, although the embodiment shown in FIG. 2 depicts each storage enclosure 211 having six storage resources 216, each storage enclosure 211 of network 200 may have any number of storage resources 216.

Although FIG. 2 depicts host 202 communicatively coupled to storage array 210 via network 208, one or more hosts 202 may be communicatively coupled to one or more storage enclosures 211 without network 208 or other network. For example, in certain embodiments, one or more storage enclosures 211 may be directly coupled and/or locally attached to one or more hosts 202. Further, although storage resources 216 are depicted as being disposed within storage enclosures 211, system 200 may include storage resources 216 that are communicatively coupled to host 202 and/or network 208, but are not disposed within a storage enclosure 211 (e.g., storage resources 216 may include one or more standalone disk drives).

In operation, one or more storage resources 216 may appear to an operating system executing on host 202 as a single logical storage unit or virtual resource 212. For example, as depicted in FIG. 2, virtual resource 212a may comprise storage resources 216a, 216b, and 216c. Thus, host 202 may “see” virtual resource 212a instead of seeing each individual storage resource 216a, 216b, and 216c. Although in the embodiment depicted in FIG. 2 each virtual resource 212 is shown as including three storage resources 216, a virtual resource 212 may comprise any number of storage resources. In addition, although each virtual resource 212 is depicted as including only storage resources 216 disposed in the same storage enclosure 211, a virtual resource 212 may include storage resources 216 disposed in different storage enclosures 211.

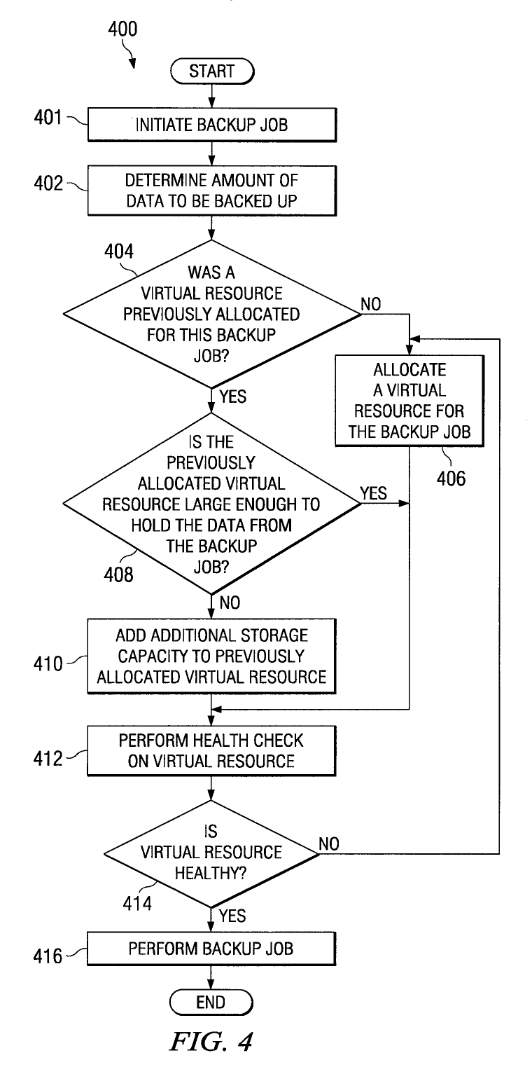

As shown in FIG. 2, host node 202 may comprise agent 204. Generally speaking, agent 204 may facilitate backing up of data by determining which data of host node 202 requires backup, and also to operable provision, monitor, and manage backup storage resources, as set forth in greater detail below with reference to FIGS. 3 and 4.

Agent 204 may be implemented in hardware, software, or any combination thereof. In certain embodiments, agent 204 may be implemented partially or fully in software embodied in tangible computer readable media. As used in this disclosure, “tangible computer readable media” means any instrumentality or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or storage.

In certain embodiments, agent 204 may be an integral part of an information handling system. In the same or alternative embodiments, agent 204 may be communicatively coupled to a processor and/or memory disposed with the information handling system.

FIG. 3 illustrates a flow chart of a method 300 for initialization of the system depicted in FIG. 2, in accordance with the teachings of the present disclosure. In one embodiment, method 300 includes starting up host node 202 and the storage enclosures 211 comprising storage array 210, determining a communication standard between host node 202 and the storage enclosures 211 comprising storage array 210, and managing the storage array 210.

According to one embodiment, method 300 preferably begins at step 302. As noted above, teachings of the present disclosure may be implemented in a variety of configurations of system 200. As such, the preferred initialization point for method 300 and the order of the steps 302-308 comprising method 300 may depend on the implementation chosen.

At step 302, each of host node 202 and storage enclosures 211 may startup. In certain embodiments, the startup of either of host node 202 or storage enclosures 211 may include powering on host node 202 or storage enclosures 211. In the same or alternative embodiments, startup of host node 202 may comprise “booting” host node 202. During startup of host node 202, agent 204 may also begin running. Likewise, during startup of storage enclosures 211, one or more storage resources 216 may also “spin-up” or begin running.

At step 304, agent 204 and/or another component of system 200 may discover that storage enclosures 211 are communicatively coupled to host node 202, whether coupled via a network, locally attached, and/or otherwise coupled. At step 306, agent 204 and/or another component of system 200 may determine a communication standard by which host node 202 is coupled to storage enclosures 211. For example, agent 204 may determine whether host node 202 and storage enclosures 211 are coupled via Fibre Channel (FC), Ethernet, Peripheral Component Interconnect (PCI), and/or another suitable data transport standard and/or protocol. At step 308, agent 204 and/or another component of system 200 may begin managing the virtual resources 212 and storage resources 216 of storage array 210 in accordance with the present disclosure.

Although FIG. 3 discloses a particular number of steps to be taken with respect to method 300, it is understood that method 300 may be executed with greater or lesser steps than those depicted in FIG. 3. Method 300 may be implemented using system 200 or any other system operable to implement method 300. In certain embodiments, method 300 may be implemented partially or fully in software embodied in tangible computer readable media.

FIG. 4 illustrates a flow chart of a method 400 for storing backup data, in accordance with the teachings of the present disclosure. In one embodiment, method 400 includes determining the amount of data to be backed up in a backup job, determining whether a virtual resource 212 was previously allocated for the backup job, and based on such determinations, allocating a virtual resource 212 for the backup job and/or adding additional storage capacity to an existing virtual resource 212.

According to one embodiment, method 400 preferably begins at step 401. As noted above, teachings of the present disclosure may be implemented in a variety of configurations of system 400. As such, the preferred initialization point for method 400 and the order of the steps 401-416 comprising method 400 may depend on the implementation chosen.

At step 401, agent 204 and/or another component of system 200 may initiate a backup job. For example, a backup job may begin when host 202, agent 204, another component of system 200, and/or a user of system 200 determines that a particular set of data is to be backed up. In the same or alternative embodiments, the backup job may comprise a regular backup of a particular set of data, e.g., a collection of data that may be backed up at regular intervals, such as daily, weekly, or monthly, for example.

At step 402, agent 204 and/or another component of system 200 may determine the amount of data to be backed up as part of the backup job. At step 404, agent 204 and/or another component of system 200 may determine whether a virtual resource 212 was previously allocated for the backup job. For example, in some embodiments, a particular set of data may be backed up to a particular virtual resource 212 on a regular basis. In such a case, a determination may be made that a virtual resource 212 has already been allocated to the backup job at step 404. If it is determined that a virtual resource 212 was not previously allocated for the backup job, method 400 may proceed to step 406. Otherwise, if it is determined that a virtual resource has been previously allocated, method 400 may proceed to step 408.

At step 406, one or more components of system 200 may allocate a virtual resource 212 for the backup job. For example, in implementations where network 208 comprises a Fibre Channel network, agent 204 and/or another component of system 200 may transmit a CREATE VIRTUAL DISK command to storage array 210 in order to create a virtual resource 212 to be allocated to the backup job. In other embodiments, an already-existing but unallocated virtual resource 212 may be allocated to the backup job. After completion of step 406, method 400 may proceed to step 412 where a health check of the allocated virtual resource 216 may be performed.

At step 408, a determination may be made as to whether a previously-allocated virtual resource 212 has large enough storage capacity to hold the data from the backup job. If it is determined that the previously-allocated virtual resource 212 does not have large enough storage capacity to hold the data from the backup job, method 400 may proceed to step 410. Otherwise, if it is determined that the previously-allocated virtual resource 212 does have large enough storage capacity to hold the data from the backup job, method 400 may proceed to step 412.

At step 410, one or more components of system 200 may respond to a determination that previously-allocated virtual resource 212 has insufficient storage capacity by adding additional storage capacity to the existing previously-allocated virtual resource 112. For example, in implementations where network 208 comprises a Fibre Channel network, agent 204 and/or another component of system 200 may transmit a CAPACITY EXPANSION command to storage array 210 in order to add additional storage capacity to the previously-allocated create a virtual resource 212 to be allocated to the backup job. In the same or alternative embodiments, a virtual resource 212 may be expanded by aggregating two or more existing virtual resources 212. After completion of step 410, method 400 may proceed to step 412.

At step 412, a “health” check on the allocated virtual resource 212 may be performed to determine if the virtual resource is functioning properly. At step 414, a determination may be made to determine whether the allocated virtual resource 212 is healthy. If, at step 414, it is determined that the health of virtual resource is not satisfactory, method 400 may proceed to step 406, where another virtual resource 212 may be allocated to the backup job. Otherwise, if it is determined that the health of virtual resource 212 is satisfactory, method 400 may proceed to step 416. At step 416, one or more components of system 200 may perform the backup job. For example, agent 204 may determine which data from host node 202 requires backup, and communicate such data via network 208 to the allocated storage resource 212.

Although FIG. 4 discloses a particular number of steps to be taken with respect to method 400, it is understood that method 400 may be executed with greater or lesser steps than those depicted in FIG. 4. Method 400 may be implemented using information handling system 100 or any other system operable to implement method 400. In certain embodiments, method 400 may be implemented partially or fully in software embodied in tangible computer readable media.

In addition to the functionality described above, system 200 may be operable to form other management tasks. For example, in some embodiments, it may desirable to de-allocate a virtual resource 212. It may be desirable to de-allocate a virtual resource 212 in numerous situations, for example, to reclaim storage capacity for backups that are no longer needed. In such embodiments, agent 204 may transmit to storage array 210 a command to delete the specific virtual resource 212, e.g., a Fibre Channel DELETE VIRTUAL DISK COMMAND.

In addition, agent 204 may monitor events, traps, and/or faults from the storage array 210, and agent 204 may manage storage array 210 in response to such events. For example, if agent 204 detects a fault in a virtual resource 212 or a storage resource 216 making up such virtual resource, agent 204 may reduce the probably of data backup loss by transmitting a command for data on such faulting virtual resource 212 to be reallocated to a healthy virtual resource 212.

Using the methods and systems disclosed herein, problems associated conventional approaches to data storage and backup power may be improved, reduced, or eliminated. Because the methods and systems disclosed may allow for an integrated agent that manages backup operations, as well as provisioning, monitoring and management of backup storage resources, management complexity of conventional approaches may be reduced or eliminated.

Although the present disclosure has been described in detail, it should be understood that various changes, substitutions, and alterations can be made hereto without departing from the spirit and the scope of the invention as defined by the appended claims.

What is claimed is:

1. A system for data storage and backup, comprising:
a storage array comprising one or more storage resources; and
an agent running on a host device, the agent communicatively coupled to the storage array and operable to:
automatically allocate one or more storage resources for the storage of data associated with a backup job of the host device; and
communicate the data associated with the backup job to the allocated storage resources.

2. A system according to claim 1, wherein:
the agent is further operable to determine an amount of data to be backed up to the storage array in connection with a backup job; and
the automatic allocation of allocated storage resources is based at least on the determination of the amount of data to be backed up.

3. A system according to claim 1, wherein:
the agent is further operable to determine if one or more of the storage resources was previously allocated for storage of the data associated with the backup job; and
the automatic allocation of allocated storage resources is based at least on the determination of whether one or more of the storage resources were previously allocated for the storage of the data associated with the backup job.

4. A system according to claim 3, wherein:
the agent is further operable to determine whether the previously-allocated storage resources have sufficient storage capacity to store the data associated with the backup job; and
the automatic allocation of allocated storage resources comprises allocation of additional storage capacity to the previously-allocated storage resources based on the determination of whether the previously-allocated storage resources have sufficient storage capacity to store the data associated with the backup job.

5. A system according to claim 1, wherein the allocation of storage resources comprises allocating a virtual resource to store the data associated with the backup job.

6. A system according to claim 1, wherein the agent is coupled to the one or more storage resources via a network.

7. A system according to claim 1, wherein the agent is further operable to:
perform a health check on the allocated resources; and
if the health of the allocated resources is unsatisfactory, allocate one or more storage resources other than the allocated resources for the storage of data associated with the backup job.

8. An information handling system, comprising:
a processor;
a memory communicatively coupled to the processor; and
an agent, the agent communicatively coupled to the processor, the memory, and one or more storage resources, the agent operable to:
automatically allocate one or more storage resources for the storage of data associated with a backup job of the host device; and
communicate the data associated with the backup job to the allocated storage resources.

9. An information handling system according to claim 8, wherein:
the agent is further operable to determine an amount of data to be backed up to the storage array in connection with a backup job; and
the automatic allocation of allocated storage resources is based at least on the determination of the amount of data to be backed up.

10. An information handling system according to claim 8, wherein:
the agent is further operable to determine if one or more of the storage resources was previously allocated for storage of the data associated with the backup job; and
the automatic allocation of allocated storage resources is based at least on the determination of whether one or more of the storage resources were previously allocated for the storage of the data associated with the backup job.

11. An information handling system according to claim 10, wherein:
the agent is further operable to determine whether the previously-allocated storage resources have sufficient storage capacity to store the data associated with the backup job; and
the automatic allocation of allocated storage resources comprises allocation of additional storage capacity to the previously-allocated storage resources based on the determination of whether the previously-allocated storage resources have sufficient storage capacity to store the data associated with the backup job.

12. An information handling system according to claim 8, wherein the allocation of storage resources comprises allocating a virtual resource to store the data associated with the backup job.

13. An information handling system according to claim 8, wherein the agent is coupled to the one or more storage resources via a network.

14. An information handling system according to claim 8, wherein the agent is further operable to:
perform a health check on the allocated resources; and
if the health of the allocated resources is unsatisfactory, allocate one or more storage resources other than the allocated resources for the storage of data associated with the backup job.

15. A method for data storage and backup comprising:
an agent running on a host device automatically allocating one or more storage resources for the storage of data associated with a backup job of the host device; and
the agent communicating the data associated with the backup job to the allocated storage resources.

16. A method according to claim 15, further comprising the agent determining an amount of data to be backed up to the one or more storage resources in connection with a backup job; and
wherein the automatic allocation of allocated storage resources is based at least on the determination of the amount of data to be backed up.

17. A method according to claim 15, further comprising the agent determining if one or more of the storage resources was previously allocated for storage of the data associated with the backup job; and
wherein the automatic allocation of allocated storage resources is based at least on the determination of whether one or more of the storage resources were previously allocated for the storage of the data associated with the backup job.

18. A method according to claim 17, further comprising the agent determining whether the previously-allocated storage resources have sufficient storage capacity to store the data associated with the backup job; and
wherein the automatic allocation of allocated storage resources comprises allocation of additional storage capacity to the previously-allocated storage resources based on the determination of whether the previously-allocated storage resources have sufficient storage capacity to store the data associated with the backup job.

19. A method according to claim 15, wherein the allocation of storage resources comprises allocating a virtual resource to store the data associated with the backup job.

20. A method according to claim 15, further comprising:
performing a health check on the allocated resources; and
if the health of the allocated resources is unsatisfactory, allocating one or more storage resources other than the allocated resources for the storage of data associated with the backup job.
